(19) United States
(12) Patent Application Publication
(10) Pub. No.: US 2007/0061694 A1
(43) Pub. Date: Mar. 15, 2007

(54) COMMUNICATION INTERFACE FOR COMMUNICATION IMPAIRED INDIVIDUALS

(76) Inventors: John H. Nortrup, Kennebunk, ME (US); Elizabeth J. Nortrup, Kennebunk, ME (US); Andrew D. Nortrup, Kennebunk, ME (US)

Correspondence Address: JOHN H. NORTRUP, 18 LONGWOOD DR., KENNEBUNK, ME, 04043, US

(21) Appl. No.: 11/530,460

(22) Filed: Sep. 9, 2006

Related U.S. Application Data
(60) Provisional application No. 60/715,946, filed on Sep. 9, 2005.

(51) Int. Cl. G06F 17/00

(52) U.S. Cl. 715/500.1; 715/730

(57) ABSTRACT

An aspect of the invention may include providing a portable computing device with a graphic user interface (GUI); capturing a plurality of images in a user defined sequence; recording an audio file, the audio file may be associated with at least one of the captured images; storing the captured image and audio to a storage file within the portable computing device; and allowing the user to display on the GUI the captured images and audio in a user defined order.

### CROSS-REFERENCE TO RELATED APPLICATIONS

This application claims the benefit of the following U.S. Provisional Patent Application, which is incorporated herein by reference in its entirety: App. No. 60/715,946 entitled “COMMUNICATION INTERFACE FOR COMMUNICATION IMPAIRED INDIVIDUALS” filed Sep. 9, 2005.

### BACKGROUND

1. Field

This invention relates to methods and systems for a graphic user interface (GUI) for communication-impaired individuals and more particularly, in providing a graphical interface on a portable computer device to display images and play associated audio for a user.

2. Background

A population of individuals exists with verbal communication impairments that may wish to communicate without the aid of others. These individuals may be capable of hearing and understanding speech, but may not be able to process a timely verbal response. These individuals may not be capable of hearing or processing speech. These individuals may rely upon devices to help them communicate their basic needs using symbols, combinations of symbols, words associated with the symbols, and the like.

The present devices typically rely upon predefined abstract graphics and symbols that the user, and people the user is communicating with, must learn to recognize prior to it being used as a communication tool. The user may select a series of these abstract graphics to indicate a sequence of events or a thought to express. These devices may only have a preset number of graphics available and may only be added as provided by the manufacturer. There may be the situation where there is not a symbol or graphic in the devices library that adequately expresses the users thoughts. Difficulties in comprehension arise when these graphics are too abstract to be readily understood by the user or the person(s) the user is communicating with, therefore limiting the functionality of the device.

These devices may be bulky and awkward to use, making them difficult to carry around for everyday situations that the user may wish to communicate to other people. This may further limit the acceptability of the device to the user. Because of the awkwardness of the device, the user may be reluctant or unable to bring the device to certain situations thereby limiting their ability to communicate in these situations.

Accordingly, a need exists to provide an image based GUI that is user specific and definable. The GUI may operate on a currently available portable computer device and may allow for the user to add their own images as defined by their individual needs, storing both actual images and associated audio.

### SUMMARY

Provided herein are methods and systems for communication providing a portable computing device with a graphic user interface (GUI); capturing a plurality of images in a user defined sequence; recording an audio file, the audio file is associated with at least one of the captured images; storing the captured plurality of images and audio to a storage file within the portable computing device; and allowing the user to display on the GUI the captured plurality of images and audio in a user defined order.

The portable computing device may be a handheld computer, a desktop computer, a tablet computer, a notebook computer, an interface screen, or the like. The interface screen may be a touch screen. The interface screen may be controlled by a pointing device, by human touch, or the like.

At least one image may be displayed on the GUI. The image may be used as a communication means to other individuals. The image may be displayed as a different format size that the original displayed image. The image may be returned to the original displayed image size.

The user may determine the sequence of the images displayed on the GUI. The image memory location may be defined in a storage file. The storage file may be at least one of an XML markup, a metadata file, a SQL database, a flat file, a relational database, a table, and a text file. The storage file may define the image display order for the GUI. There may be a parent image. There may be associated child images to the parent image. A child image may be a parent image to other child images.

The database may be initially empty. The user may define the image sequence in the database. The user may add an image to the database. The image may be at least one of a clipart file, a JPG file, a TIFF file, a BMP file, and a GIF file. The user may delete an image. Child images may be deleted with the associated parent image.

Images may be captured using a camera. The camera may be at least one of a digital camera and a film camera. The film camera images may be converted to a digital format. The camera may be connected to the portable computing device. The image may be displayed on the portable computer device before capture. User input may be provided to capture the image from the connected camera. The camera may capture images to a storage file. Captured images may be automatically sized for optimum display.

Images may be captured with an external digital camera. The images may be transferred to the portable computer device. The images may be captured with an external film camera. The film images may be converted to digital images. The images may be transferred to the portable computer device.

A user interface may allow for manipulation of image display order. The interface initially may contain no images. The user may add images to fit personal needs. The user may determine which child image is associated with a parent image. The user may determine which child image is subordinate to a parent image. The images may be associated to a storage file. A storage file may point to the image storage location. The storage file may maintain child image association to parent image. The storage file may maintain a tree structure of associated images. Images may be displayed in tree structure order. The user may add images to the tree structure. The GUI may have an add function to add images to the tree structure. The images may be added to the active tree structure layer. An image title may be input to describe the image. The user may delete images from a tree structure level. An input may be provided to delete an image from the tree structure layer. Child images of the parent may be deleted with the parent image. The images may be displayed with image title.

The user may navigate between images on the GUI. An input may be provided to move down a tree structure layer. The images of the next tree structure layer may be displayed on the GUI. An input may be provided to move up a tree structure layer. The images of the previous tree structure layer may be displayed on the GUI. Additional images of the same tree structure layer may be accessed. Navigation may be for next images on the tree structure layer. Navigation may be for previous images on the tree structure layer. The number of layers may only limited by memory of the portable computer device.

Audio may be recorded for the images. The audio may be a digital recording, an analog recording, or the like. The audio may be associated to an image. An interface may be provided for the capture of audio. The interface may display the image to associate audio. There may be an audio capture start, an audio capture stop, or the like. The audio may be recaptured. The audio may be played for a displayed image. User input may play audio associated to image. The audio may be used as a communication means to other individuals. The audio memory location may be maintained by the storage file. The storage file may associate the images and the audio files. The amount of audio may only limited by amount of portable computer device memory.

An interface from an external device provides file maintenance to the GUI. The external device may be at least one of a computer, a handheld computer, a notebook computer, a tablet computer, a cell phone, a memory card reader, a network server, and an Internet server. The external device may be an automated network service. Files may be transferred between the external device and the GUI. The storage file may be transferred. Image files may be transferred. Audio files may be transferred. Files may be transferred as a means of backup. Files may be synchronized between the external device and the GUI. The files may be moved between the portable computer device and external device. The image files may be automatically resized for optimum storage and display size. The connection to the external device may be a wired connection, a wireless connection, or the like.

Updates may be provided to the GUI. The updates may be for new executable files. The updates may be provided by at least a CD, DVD, and flash memory. The updates may be provided by connection to an Internet location. The portable computer device may connect to the Internet. An external device may connect to the Internet.

The GUI may be used to communicate to other people. The image may be shown to the other person. The image may communicate the user's needs. The user may navigate to an appropriate image for display to the other person. The audio related to the image may be played for the other person. The audio may communicate the user's needs. The user may navigate to an appropriate image to play the associated audio. The other person may use the communication interface to communicate to the user. The other person may navigate to an image to show to the user.

The portable computer device may be connected to a GPS device. The GUI may receive the location of device from the GPS device. The location may be displayed on the GUI. Directions may be given to another location on the GUI.

The portable computer device may be a cell phone. The user may dial a phone number by indicating an image. The GUI may play an audio after a connection is made. The audio may be the location of the GUI.

### BRIEF DESCRIPTION OF FIGURES

The systems and methods described herein may be understood by reference to the following figures:

FIG. 1 shows a schematic of the significant components of the GUI.

FIG. 2 shows a more detailed view of the GUI.

FIG. 3 shows a detailed view of the user interface for adding and editing images and audio to an active level.

FIG. 4 shows a tree structure indicating images and audio files associated in layers and parent to child relationships.

FIG. 5 shows an embodiment of capturing images from a connected camera.

FIG. 6 shows the GUI communicating with an external device and the internet.

FIG. 7 shows an embodiment of the portable communication device displaying the GUI interface.

FIG. 8 shows an embodiment of communications between a parent and a teacher using the GUI.

FIG. 9 shows an embodiment of a user communicating with the GUI at a restaurant.

FIG. 10 shows an embodiment of a user determining a sequence to be followed in a kitchen.

### DETAILED DESCRIPTION OF FIGURES

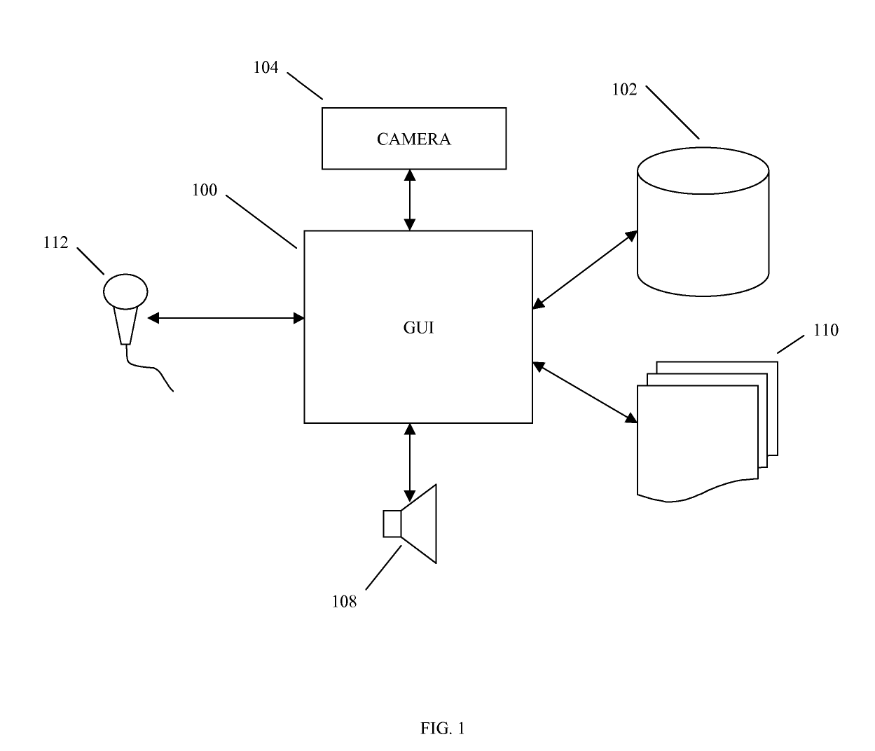

Referring to FIG. 1, a schematic of the portable computer device is shown with components that may embody the graphic user interface (GUI). The GUI may use the entirety of the GUI (Graphical User Interface) 100. An embodiment of a portable computer device may include a GUI 100, storage capacity to contain storage files 102 and image/audio/text files 110, interface slots capable of accessories such as a camera 104, internal microphone 112, external microphone, a built-in speaker 108, and the like.

The portable computer device may have a GUI 100 that may provide touch screen technology capability. The touch screen GUI 100 may allow the user to interact with the GUI 100 using a stylus, touch of a finger, or other pointing device. The inputs provided by the GUI 100 may be of sufficient size that the user may be able to use his or her fingers as the pointing device and negate the need to hold a standard pointing device. The GUI 100 may be capable of displaying text and images in full color that may be displayed in an order defined by the user.

The memory of the portable computing device may be capable of containing storage files 102, image/audio/text files 110, or other type of computer files. In an embodiment, the GUI 100 may be able to interface with the memory and access the storage file 102 for use in determining the display characteristics of the GUI 100. For example, the GUI 100 may allow the user to select an image for display; the image may be stored in memory. In an embodiment, the user input may initiate a search of the storage file 102 that may find the user requested image/audio/text file 110. With the image/audio/text file 110 identified, the GUI 100 may display the image, display text, play the associated audio, or the like.

In an embodiment, the portable computer device may contain an interface slot for additional functionality that may permit a plurality of external devices such as memory cards, cameras 104, or the like. With a camera 104 attached to the portable computer device, a user may be able to capture images and store them in the memory as supported image type files 110. In an embodiment, these images may be saved to the storage file 102 for later user recall and display on the GUI 100. After an image is captured by the camera 104, the image file 110 may be automatically converted to an optimized size for display on the GUI 100. For example, the camera may be capable of capturing images of a size that is larger than required to be displayed on the small GUI 100 of the portable computer device. The image may be automatically reduced in size (e.g. number of pixels) for acceptable display on the GUI 100 and provide maximum storage space on the portable computer device. The images may be stored as clipart, JPG, TIFF, BMP, GIF, or other image format supported by the portable computer device.

The portable computer device may have a built-in microphone 112 and speaker 108 that may permit audio capture and playing of audio. Through the GUI 100, the user may be able to capture audio using the microphone 112 and may save the audio as an audio file 110 in memory. In an embodiment, once the user has captured an audio, the user may be able to associate the audio with an image. When selected by the user, the image-associated audio may be played on the portable computer device speaker 108.

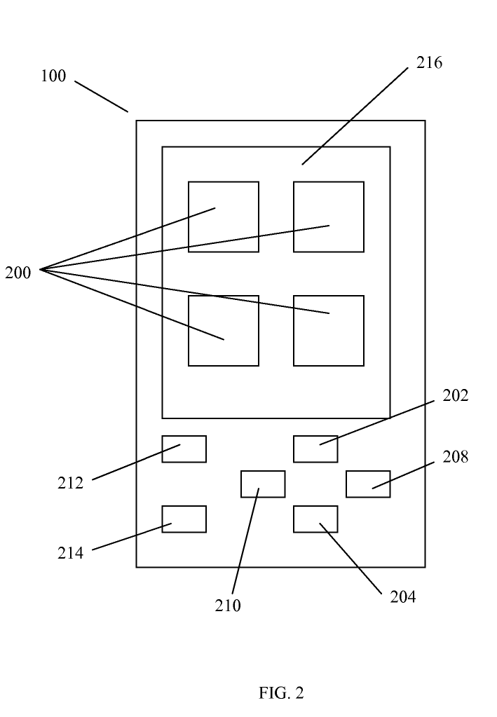

Referring to FIG. 2, an embodiment of the GUI 100 with an input object (image) 200 is shown. In an embodiment the GUI 100 may be divided into areas of a display 216 where images 200 may be displayed and input objects 202, 204, 208, 210, 212, and 214 may be provided to allow the user to navigate, revise, add, or the like to the GUI 100.

In an embodiment, the display area 216 may provide a location for the display of a plurality of images 200 that may have been viewed, added, deleted, or the like by the user. In an embodiment, the images 200 displayed may be part of the same level or family of images. In an embodiment, the images 200 may display separate image topics that may be navigated by the user to locate and display other associated images, image topics, or the like. In an embodiment, an image topic may be an image heading that may indicate what other images may be associated with the image topic. For example, an image topic may have a picture of a refrigerator to indicate the other images associated with this image topic contain images of the objects within the refrigerator.

In an embodiment, when the user first receives the portable computer device with the GUI, there initially may be no images displayed in the image area 216. In an embodiment, the user may add images to the image area 216 that may define general topics that are important to the user that may include images of a house, food, family, school or business, or the like. In an embodiment, additional images may be associated to the general image topics. In an embodiment, the additional images may be organized as a tree structure with a second image a child of a first image. There may be as many second images associated to the first image as the user desires. In an embodiment, as the user navigates from a first image to a second image, the images may become more specific in nature to further define the idea the user is trying to express. For example, a general image may be of a house, the next level of images may be of the various rooms of the house such as kitchen, living room, bathroom, or bedroom. An additional level from a bedroom image may be particular images of the users bedroom such as a desk, lamp, or bed. In this manner the user may be able to locate and display to another person, particular images that may be important to the user to express ideas that the user may not be able to express verbally.

In an embodiment, to facilitate navigating from one image to another image, navigation inputs 202, 204, 208, and 210 may be provided. There may be an unlimited number of images in a level or family of the image tree structure; the number of images may be more than is can be displayed in the image area 216. In an embodiment, when there are more images 200 than available space in the image area 216, a right navigation button 208 and a left navigation button 210 may be provided to scroll right and left to view all of the images 200. By providing input to the right navigation button 208, the images 200 in the image area 216 are replaced the next available images 200, effectively scrolling to the right. In the same manner, the left navigation button 210 may be input to show the last previously shown images 200, effectively scrolling to the left. To move between image tree levels, the up navigation button 202 and down navigation button 204 may be provided. In an embodiment, to move down a level from a first image, the user may select the first image 200 to display more detail and then may press the down navigation button 204. This action may display the child images 200 associated with the first image 200. Once on this new level the user may again be able to navigate both right and left to see all of the images 200 of the new level. In an embodiment, if the selected image 200 is the last image in the child tree structure, the image 200 may be display in an enhanced larger size that may provide improved viewing of this last image in the tree structure. In an embodiment, the user may input the up navigation button 202 and the images 200 of the previous or next higher level may be displayed. In this manner, the full range of images 200 from the starting images of the image tree to lower images of the image tree may be displayed by the user and used as a GUI to another person.

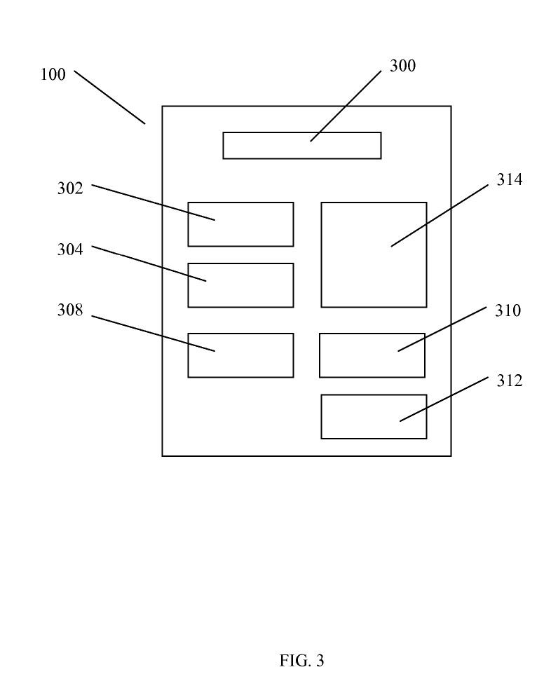

In an embodiment, the user may want to add a new image to a particular image tree level, to a parent image, or the like. In an embodiment, by activating the add object 212, the user may gain access to another interface for adding an image or audio. In an embodiment, the user may select an image in the image area 216, and the new added image may be associated to this image as a child image. For example, the user may wish to add an image of milk to the refrigerator, the user may select the refrigerator image and select the add object 212 to add the milk image as a child to the refrigerator image. In an embodiment, if no image is selected in the image area 216, then the new image may be added to the existing image tree level. The add interface is described in more detail in FIG. 3.

In an embodiment, the GUI 100 may have an input object to make a selected image 200 larger in size and allow other functions in association to the image 200. In an embodiment, by selecting an image 200 and then providing an input to the size button 214, the image 200 may be fill the entire image area 216 for enhanced viewing. In an embodiment, when the image 200 is in the enhanced mode, other options such as return, listen to audio, add, and edit may be available. In an embodiment, if there is a captured audio associated with the image 200, the listen input may be activated and the audio may be played. In an embodiment, the playing of the audio by the user to another person may enhance the understanding of the other person as to the user's communication intent. In an embodiment, by providing input to a return object, the user may be returned to the previous level of images 200 from the larger image that was being displayed. By providing input to the add or edit object, the GUI 100 may display a new window to allow the user to add a new image 200 or edit the highlighted image 200 properties. These inputs are fully described in FIG. 3.

FIG. 3 shows an embodiment of the GUI 100 after a user has chosen either the add or edit objects from the GUI 100. In an embodiment, the add or edit interface may include a title input field 300, choose image input 302, record input 304, OK input 308, cancel input 310, delete input 312, an image preview area 314, or the like.

In an embodiment, the title input field 300 may be used by the user to create the title that may be associated and displayed with the image 200 on the GUI 100. In an embodiment, the input title may be displayed in association with the image to further describe what the image represents.

In an embodiment, the choose image input 302 may be used by the user to select an image from image/audio/text files 110 for display on the GUI 100. In an embodiment, by activating the choose image input 302, a typical directory browse window may be displayed with directory selections so an image may be chosen by browsing through available images in image/audio/text files 110. In an embodiment, after an image is selected in the browse window, the image may be shown in the image preview area 314 as a verification of the correct image being chosen. In an embodiment, the user may be editing the properties of an existing image 200 and the existing image 200 may be displayed in the image preview area 314. In an embodiment, regardless of an existing image being displayed in the image preview area 314, if the user chooses another image using the choose image object 302 the image in the image preview area may display the new image.

In an embodiment, the record input 304 may permit the capturing of audio that may be associated with the selected image displayed in the image preview area 314. In an embodiment, by activating the record input 304 the user may capture audio from the portable computer device internal microphone 112. In an embodiment, during the audio capture, the user may be presented with a stop record input to be activated when the audio capture is complete. In an embodiment, the audio may be recaptured to either improve or change the audio associated with the image displayed in the image preview area 314. In an embodiment, the previous captured audio may be replaced by the newly captured audio.

In an embodiment, a typical OK input 308 may be provided to accept all title input 300, image selection, audio captured, or the like using this interface. In an embodiment, the user may select the OK input 308 to complete the add or edit function of the GUI 100 with acceptance of the display information. In an embodiment, once the OK input 308 is activated, the GUI 100 may save the title, image, and audio to the storage file 102 and may place this information in the proper location in the storage file 102 to provide the proper sequencing to a parent image 200.

In an embodiment, a cancel input 310 may be provided to not accept any of the changes made in this interface. In an embodiment, the user may select the cancel input 310 to complete the add or edit function without making any of the changes shown in the interface. In an embodiment, the selection of the cancel input 310 may not add or delete any information to the storage file 102.

In an embodiment, if the user had chosen to edit an existing image from the GUI 100, a delete input 312 may be present. In an embodiment, the selection of the delete input 312 may remove the image displayed in the image preview area 314 from the GUI 100. In an embodiment, with the selection of the cancel input 312, the information for the associated image, title, and audio being edited may be removed from the GUI 100 and storage file 102. In an embodiment, if the image 200 was a parent image to associated child images, both the parent and child images may be deleted from the GUI 100 and storage file 102. In an embodiment, during the deleting process to remove an image 200, there may be a confirmation screen to request the user to confirm the deletion.

In this manner, a user may be able to capture a series of images that describes part of their day, a task, a job, or other aspect of life that they want to express to others. In an embodiment, a generic image may be used as a category and the captured images may be associated to the generic image to be displayed on a level. The user may then be able to navigate through the images in order to form a type of conversation with another person. At a later date, when this information may not be relevant, the user may delete the entire sequence of images.

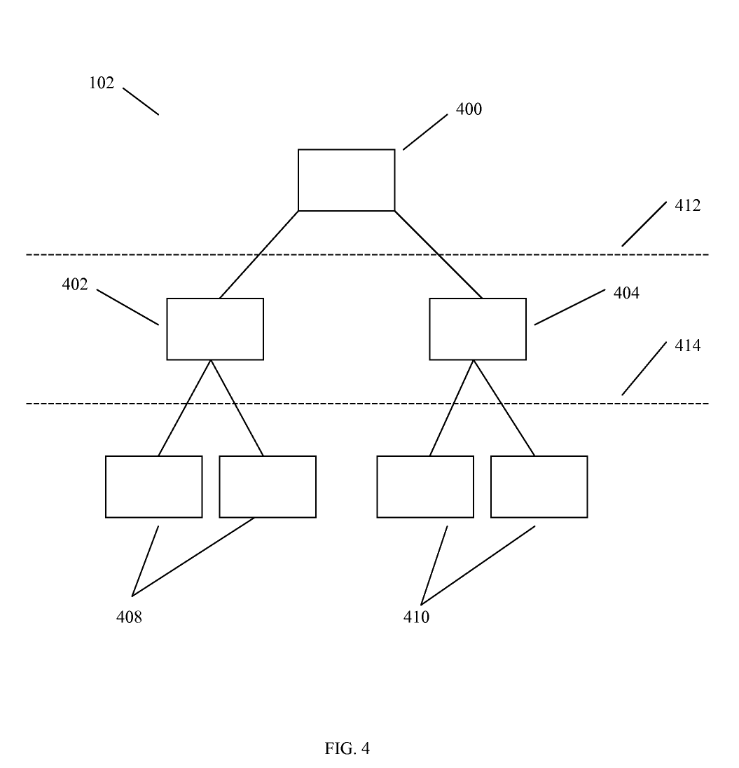

Referring to FIG. 4, an embodiment of a tree representation is shown that describes the way image/audio/title objects are associated as a tree structure in the storage file 102. In an embodiment, a stored description of an image 200 in this tree may include the image memory location, audio memory location, image title, and the like. The storage file may be a XML markup file, a metadata file, a SQL database, a textual file, or other database file supported by the portable computer device. In an embodiment, there may be a parent image/audio/text object 400 that describes a general topic for the user. In an embodiment, this general topic 400 may have more detailed image/audio/text information associated to it as objects 402 and 404. As described above the image/audio/text object 400 may be on a top level as illustrated by the line 412. The child image/audio/text objects 402 and 404 create a second level that may be navigated to using navigation inputs (202, 204, 208, 210). In an embodiment, the user may activate the down navigation input 204 to move down the tree from object 400 to have the GUI 100 display objects 402 and 404 from the second level. In an embodiment, the user may select one of the second level objects 402 or 404 and again select the down navigation input 204 and may traverse the tree to a third level as denoted by line 414. In an embodiment, if the user had traversed from object 402 the third level objects 408 may be displayed on the GUI 100. Likewise, if the user traversed down from object 404 the third level objects 410 may be displayed on the GUI 100. In an embodiment, using the up navigation input 202 the user may traverse up the tree from a lower level to a higher level. In an embodiment, if there are more image/audio/title objects to be display from a level that can be displayed on the GUI 100 the user may use the right navigation input 208 or left navigation input 210 to traverse right or left across a level. In an embodiment, each image/audio/text object may have associated child image/audio/text objects forming other branches of the tree. In an embodiment, there may be no limit to the number of levels down from a parent level along a path of the tree.

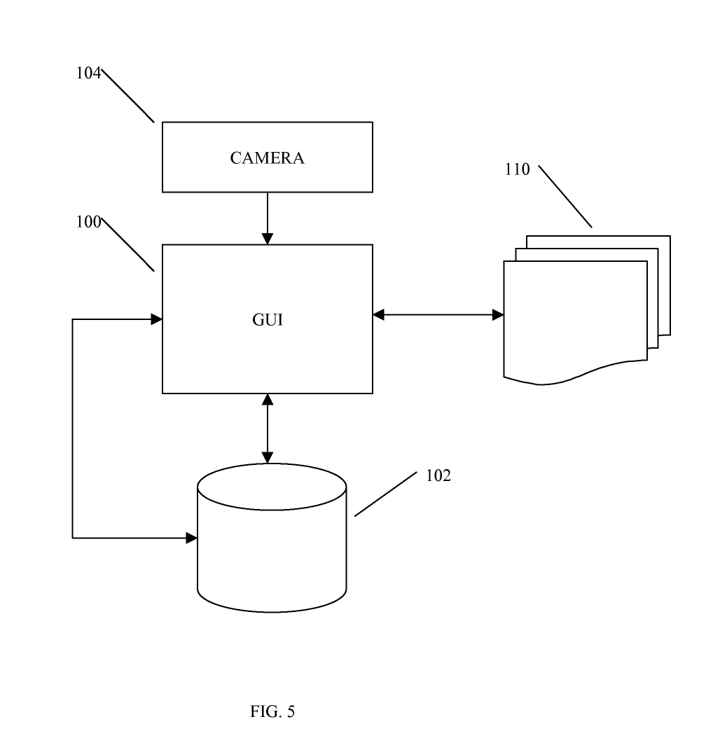

FIG. 5 shows an embodiment of a schematic of a camera 104 connected to the portable computer device and interacting with the GUI 100, storage file 102, image/audio/text files 110, or the like. It may be advantageous for the user to have the capability to capture his/her own images to further define aspects that they wish to express. With an attached camera 104 the user may see something that they wish to have in the image library of the portable computer device and may be able to capture it. In an embodiment, during the image capture process; an image may be display on the GUI 100 allowing the user to frame the image to be captured. In an embodiment, the user may add an image to the portable computer device memory where the image is clipart, JPG, TIFF, BMP, GIF, or other image format supported by the portable computer device. In an embodiment, the user may select an input object to indicate the to the GUI 100 to capture the displayed image.

In an embodiment, with the selection of the image displayed on the GUI 100, the GUI 100 may store the image in memory with other image/audio/text files 110. In an embodiment, the image may be sized to an optimal size during the storage process. For example, the camera may be able to capture images 800×600 pixels and during the saving process to the storage file 102 the image may be compressed, resized, or the like to a smaller format that may provide to proper display on the GUI 100.

In an embodiment, using the add process described in FIG. 3, the user may select an image from the image/audio/text files 110 and store the file locations in the storage file 102 to add the image/audio/text files 110 to the tree as described in FIG. 4. In an embodiment, the storage file 102 may interact with the GUI 100 to display the image from the image/audio/text file 110 location.

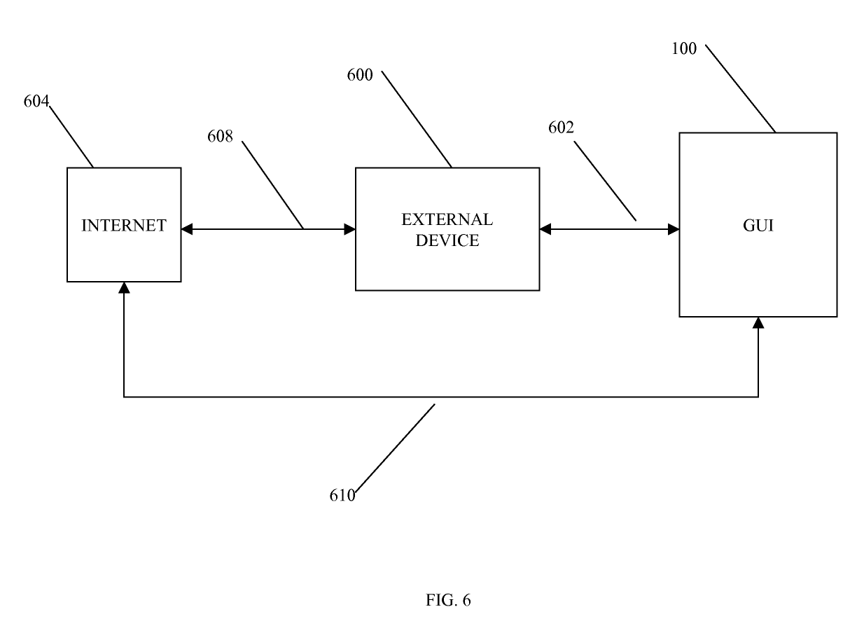

Referring to FIG. 6 an embodiment of a schematic shows the interfacing of the GUI 100 to an external device 600 and the Internet 604. In an embodiment, the GUI 100 may be able to communicate with an external device 600 that may include a computer, a handheld computer, a notebook computer, a tablet computer, a cell phone, a memory card reader, a network server, an internet server, or the like. In an embodiment, the GUI 100 may communicate to the external device 600 through a connection 602 by wire such as serial or USB connection, wireless, IR, or other communication protocol. In an embodiment, the external device 600 may provide an interface that may provide synchronization of files to the portable computer device and the external device 600. In an embodiment, the external interface may be able to transfer files from the portable computer interface to the external device 600, from the external device 600 to the portable computer device, or the like. In an embodiment, the interface may provide for a selection tree that the user may be able to choose which files are to be transferred and in which direction. In an embodiment, the user may also be able to select a synchronization option that may copy files between the two devices using file date or other file characteristic to determine which is the file to be saved or overwritten.

To further aid in the creation of the GUI 100 storage file 102 and image/audio/text files 110, the external device 600 may have a version of the GUI 100 where the storage file 102 may be additionally create. In an embodiment, the external device 600 interface may then be used to transfer the storage file 102 and the image/audio/text files 110 to the portable computer device.

In an embodiment, the portable computer device GUI 100 may be able to interface with the Internet 604. In an embodiment, this communication may be through the external device 600 using connection 602 and 608. In an embodiment, connection 608 may use the appropriate protocol for the external device to interface with the Internet 604. In an embodiment, the portable computer device may be able to communicate directly to the Internet using connection 610 by accessing a wireless network.

In an embodiment, the capability of the portable computer device to communicate with the Internet 604 may allow the portable computer device to download new images 200 from the Internet 604, upload images to the Internet 604, retrieve GUI 100 updates, or the like. In an embodiment, the Internet connection 610 may allow the portable computer device to save and retrieve images, audio, text, or the like from a website on the Internet 604.

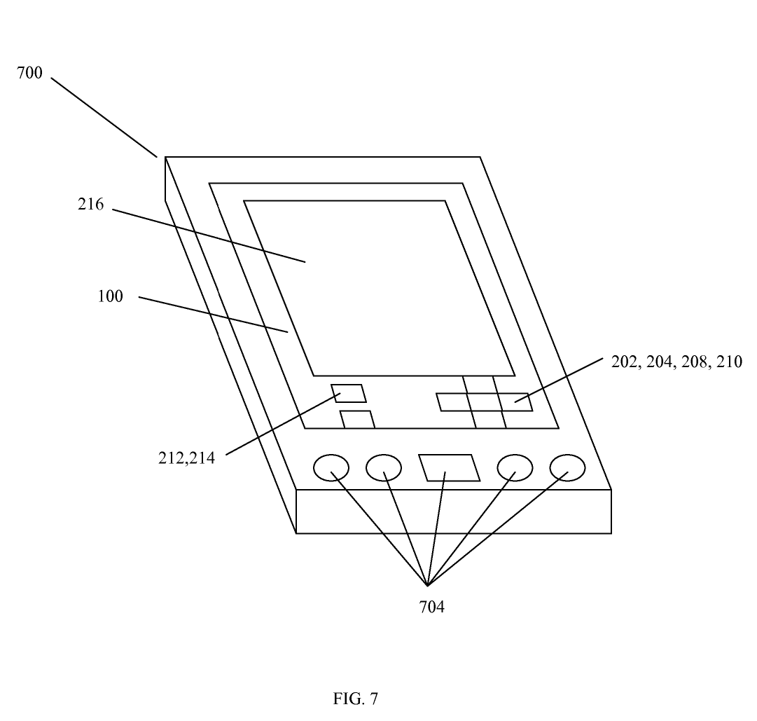

Referring to FIG. 7 an embodiment of the GUI 100 is shown operating on a portable computer device 700. The portable computer device 700 may be a typical device available to the public that may be small and lightweight. These devices may typically be carried by a person in a pocket, purse, a backpack, around the neck with a strap, or other convenient means of carrying the small device. Individuals often use these portable computer devices to keep calendars, work on documents, email, browse the Internet 604, or other task available on such a computer device. The portable computer device 700 may typically have portable computer device navigation buttons 704 that may allow a user to activate various functions on the portable computer device 700 and the portable computer device 700 may have a standard operating system that may be included with the portable computer device.

In an embodiment, a user may initially receive the GUI 100 with no images displayed in the image area 216. With no images displayed on the image area 216, the storage file 102 may also be empty with no reference to saved image/audio/text file 110 locations. In an embodiment, when the user first receives the GUI 100, there may be an image library available to allow the user to begin to add images to the image area 216 and into the storage file 102. The user may use the navigation (202, 204, 208, 210) and modification inputs (212, 214) on the GUI 100 to start adding images to the image area 216 and then continue on to create a tree structured storage file 102, as described above, for a complete image description of important items. In an embodiment, the GUI 100 image collection may never be complete, the user may be able to continue to add/modify/delete images on the GUI as the user desires and is defined by the size of the storage file 102. In an embodiment, the user may continue to add images to the GUI 100 by capturing their own images, as described above, to make the GUI 100 even more personal and useful for the user.

In an embodiment, with the user receiving the GUI 100 with the image area 216 blank and the storage file 102 empty, the user may be able to establish a personal image organization. In an embodiment, the ability to personalize the image organization may make the GUI unique to each user. Each individual user may start with images that are meaningful to them and these images may be different from other users. In an embodiment, the personalization of image organization may allow for uniquely organized communication devices for each user. In an embodiment, with the ability to create a uniquely organized GUI 100, the user may always know where each image is and may make finding a needed image in the tree structure an easy task. This may be analogous to each individual person having a unique filing system for their home paperwork, they will always know where to look for a paper because they put it there.

In an embodiment, the personalization of image organization may allow the GUI 100 to be useful to a wide range of individuals with a variety of verbal impairing illnesses and disorders. These disorders may be, but not limited to, Pervasive Developmental Disorders, Autistic Disorders, Rett's Disorder, Childhood Disintegrative Disorder, Asperger's Disorder, Pervasive Developmental Disorder Not Otherwise Specified (PDDNOS), Fragile X Syndrome, Amyotrophic Lateral Sclerosis (ALS, Lou Gehrig's Disease), Apraxia in Adults, Apraxia in Children, Alzheimer's Disease, Dysarthria, Huntington's Disease, Mouth and Throat Cancers, Right Hemisphere Brain Damage, Traumatic Brain Injury, Selective Mutism, Speech Disorders, Deafness, Hard-of-Hearing, Cerebral Palsy, Muscular Dystrophy, and/or other Speech and Language Impairments. This list of disorders and illnesses should not be viewed as a complete list, there may also be other disorders that impair an individual's communication that may also benefit from the GUI 100.

In an embodiment, these many different verbal impaired illness and disorders may present different levels of verbal communication impairment. Some of the illnesses and disorders may only create difficulty for an individual to think of the first thing that they want to say. In an embodiment, this individual could use the GUI to help them remember what they wanted to say or to perform a task they need to remember. Some of these individuals may also be able to use the GUI 100 as a learning or teaching tool. As an example, an individual suffering from a stroke may be able to use the GUI 100 for a short time until they are able to achieve independence again.

In an embodiment, some of the individuals with one of these illnesses or disorders may need more aid in communication and may need to use the GUI 100 to fully communicate for them. In an embodiment, these individuals may be able to use the GUI 100 to navigate using the navigation inputs (202, 204, 208, 210) to find the image need to communicate to another individual what they are trying to say. The user may also play the associated audio for the image to make the communication even more clear.

In an embodiment, some of these individuals may only need the GUI 100 to allow them time to think of an appropriate response to another individual. These users may only navigate to the desired image just to clarify their thoughts and then speak for themselves. Other individuals may need to use the GUI 100 to communicate for them by finding the desired image and showing the image to the other individual. If needed the user may also play the associated audio for the other user to make their ideas more clear.

In an embodiment, for many of these individuals the use of picture images on the communication device may make it easier to communicate to other individuals. The images may include images to express emotional needs and feelings as well as physical needs. The images may be easily recognizable and understandable to the user and therefore make it easy to organize the GUI 100 with clear images demonstrating their meanings.

In an embodiment, another use for the GUI 100 may be for immediate emergency information and identification in the event that an individual is injured. The GUI 100 may contain emergency contact information and personal information that may be easily found. The emergency information may be contacts of another individual that may be able to help the injured user. The personal information may the standard information for use by a person providing medical aid or specific emergency medical requirements of the user.

In an embodiment, with the aid of the GUI 100, which provides access to real life images and audio, the user may be provided with a level of self-confidence in the ability to communicate with other individuals. The user may be provided with the empowerment for the directing of the user's likes, dislikes, needs or desires. This level of self-confidence and empowerment may provide additional independence for the user in that the user may be able take a more active part in more social situations. With certain users and certain situations, this may result in an ongoing acquiring of independence for the user and a lessening of a need for a constant caregiver for the transferring of basic information to other individuals.

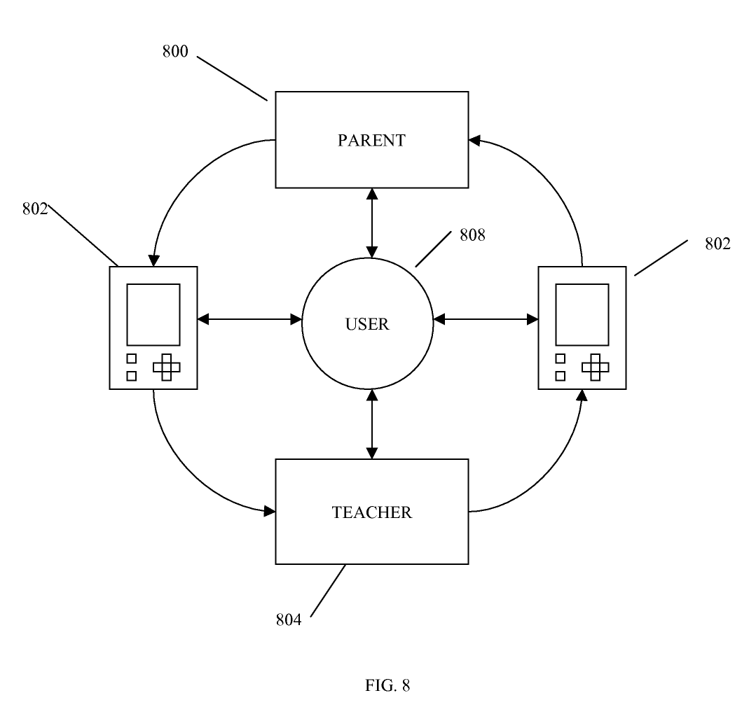

Referring to FIG. 8, an embodiment of how the portable computer device 802 using the GUI 100 may work in parent teacher communications. The user 808 may not be able to communicate to a teacher 804 information on how the user's day has started, if there were problems on any homework, special after-school instructions or other information the parent 800 may want to express to the teacher 804. The parent 800 and teacher 804 may communicate to each other using the portable computer device 802 using the GUI 100.

In an embodiment, the parent 800 may be able to capture images on the portable computer device 802 using the GUI 100 that the parent 800 wishes to communicate to the teacher 804. In an embodiment, the parent 800 may be able to record information about each one of the images that are captured that morning. The user 808 may then carry the portable computer device 802 using the GUI 100 to the teacher 804 where the teacher 804 may be able to review the images and audio sent by the parent 800. In an embodiment, the ability of the teacher 804 to see and hear the issues the parent 800 is communicating may greatly enhance the teacher's 804 understanding of the needs of user 808 for that day.

In an embodiment, the user may not be able to communicate to the parent 800 what activities the user 808 did during the day. In an embodiment, the teacher 804 may be able to capture images and audio during the day to make a small diary for the parent 800 to view at the end of the day. The teacher 804 may be able to add audio to the images to further explain the meaning of the images. The user 808 may then carry the portable computer device 802 using the GUI 100 home where the parent 800 may review the images of the day. This ability to see and understand the activities of the day for user 808 may allow the parent 800 an enhanced understanding of the day of the user 808.

In an embodiment, by using this circle of communication, the parent 800 and teacher 804 may be able to greatly improve the care and teaching of the user 808. In an embodiment the user 808 may benefit by having a less stressful environment because the portable computer device 802 using the GUI 100 may provide information that the user is unable to communicate.

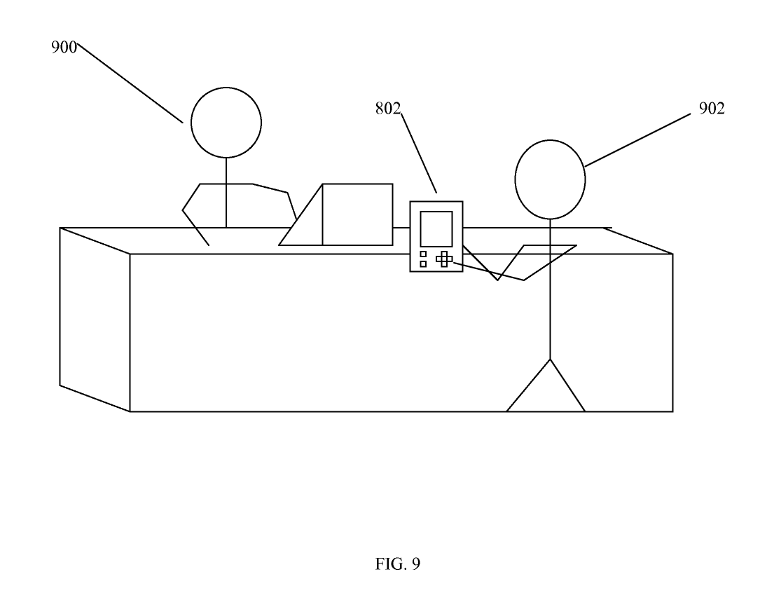

Referring to FIG. 9, an embodiment of the user 902 ordering food using the portable computer device 802 using the GUI 100 is shown. In an embodiment, the user 902 may be able to indicate what the user 902 wishes to order by navigating on the portable computer device 802 using the GUI 100 to an image of the desired food. The user 902 may then show the image on the portable computer device 802 using the GUI 100 to the waitperson 900 enabling the user to order food independently. In an embodiment the user may also play the audio associated to the image to make the order more clear to the waitperson 900.

In an embodiment, the user 902 may further enhance the understanding of the images by the waitperson 900 by having previously captured images of the food from that particular restaurant. The waitperson 900 then may be able to clearly understand the meaning of the images on the portable computer device 802 using the GUI 100 shown by the user 902.

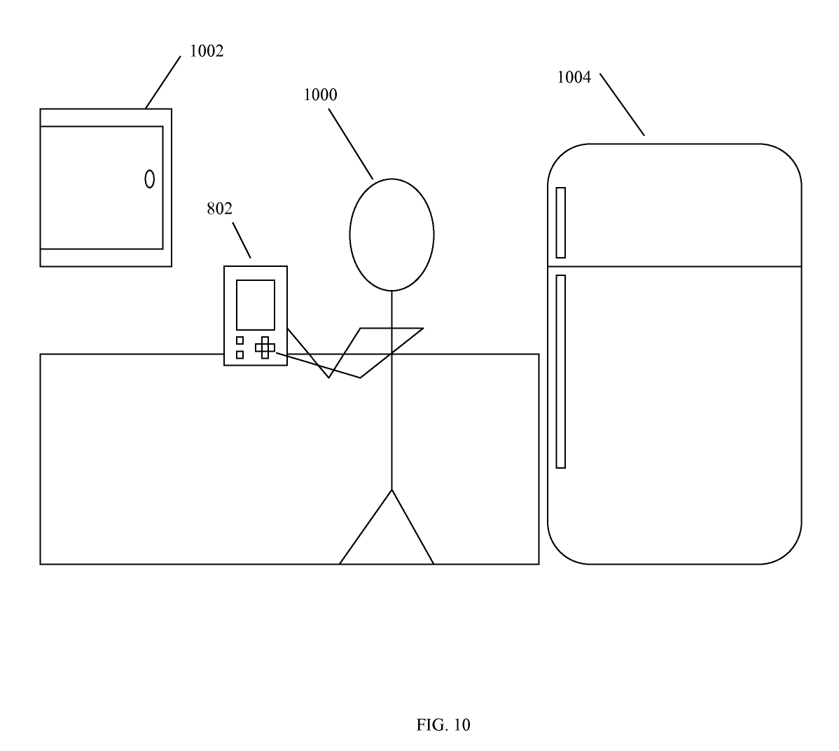

Referring to FIG. 10, an embodiment of the portable computer device 802 using the GUI 100 assisting in remembering a sequence in a task is shown. The user 1000 may not be able to remember all the steps in a task and may use the portable computer device 802 using the GUI 100 to help remember the proper sequence.

In an embodiment, an example of the user getting a drink from the refrigerator may be used. The task may seem simple, but for a person with an illness or disorder, even a simple task may be difficult to remember. In an embodiment, the portable computer device 802 using the GUI 100 may show a sequence of go to the kitchen, go to the cupboard 1002, open the cupboard 1002, take out a glass, go to the refrigerator 1004, open the refrigerator 1004 door, retrieve the drink container, pour the drink into glass, put away the drink container, and close the refrigerator 1004 door.

Many of the stresses in the lives of individuals with some of the mentioned illnesses and disorders is the frustration of not being to remember how to accomplish a task on their own. The portable computer device 802 using the GUI 100 may be able to guide the user through a task and reduce the stress levels associated with that task.

While the invention has been described in connection with certain preferred embodiments, other embodiments would be understood by one of ordinary skill in the art and are encompassed herein.

1. A method of communication, comprising:
providing a portable computing device with a graphic user interface (GUI);
capturing a plurality of images in a user defined sequence;
recording an audio file, the audio file is associated with at least one of the captured images;
storing the captured plurality of images and audio to a storage file within the portable computing device; and
allowing the user to display on the GUI the captured plurality of images and audio in a user defined order.

2. The method of claim 1, wherein the portable computing device is a handheld computer.

3-9. (canceled)

10. The method of claim 1, wherein at least one image is displayed on the GUI.

11-13. (canceled)

14. The method of claim 10, wherein the user determines the sequence of the images displayed on the GUI.

15. The method of claim 14, wherein an image memory location is defined in a storage file.

16. The method of claim 15, wherein the storage file is at least one of an XML markup, a metadata file, a SQL database, a flat file, a relational database, a table, and a text file.

17. The method of claim 15, wherein the storage file defines the image display order for the GUI.

18. The method of claim 17, wherein there is parent image.

19. The method of claim 17, wherein there are associated child images to the parent image.

20. The method of claim 19, wherein a child image is a parent image to other child images.

21-39. (canceled)

40. The method of claim 1, wherein the GUI allows for manipulation of image display order.

41. The method of claim 40, wherein the GUI initially contains no images.

42. The method of claim 41, wherein the user adds images to personal needs.

43. The method of claim 40, wherein the user determines which child image is associated with a parent image.

44. The method of claim 40, wherein the user determines which child image is subordinate to a parent image.

45. The method of claim 40, wherein the images are associated to a storage file.

46. (canceled)

47. The method of claim 45, wherein the storage file maintains child image association to parent image.

48. The method of claim 45, wherein the storage file maintains a tree structure of associated images.

49. The method of claim 48, wherein images are displayed in tree structure order.

50-117. (canceled)

118. A system of communication, comprising:
a portable computing device with a graphic user interface (GUI);
a plurality of images captured in a user defined sequence;
an audio file recorded, the audio file is associated with at least one of the captured images;
the captured plurality of images and audio stored to a storage file within the portable computing device; and
the user allowed to display on the GUI the captured plurality of images and audio in a user defined order.

119-234. (canceled)
